(19) United States
(12) Patent Application Publication
(10) Pub. No.: US 2005/0113602 A1
(43) Pub. Date: May 26, 2005

(54) Preparation of an alkenylphosphonic acid derivative

(76) Inventors: Roland Kessinger, Weinheim (DE); Jan-Dirk Arndt, Mannheim (DE); Jochem Henkelmann, Mannheim (DE); Florian Thomas, Ludwigshafen (DE)

Correspondence Address: NOVAK DRUCE DELUCA & QUIGG, LLP, 1300 EYE STREET NW, SUITE 400 EAST, WASHINGTON, DC, 20036, US

(21) Appl. No.: 10/977,449

(22) Filed: Nov. 1, 2004

(30) Foreign Application Priority Data
Oct. 30, 2003 (DE) 10350676.4

(51) Int. Cl. C07F 9/22

(52) U.S. Cl. 562/8

(57) ABSTRACT

Process for preparing an alkenylphosphonic acid derivative by reacting a phosphonic acid derivative with an alkyne in the presence of a catalyst complex system, wherein the catalyst complex system comprises (a) nickel and (b) a phosphine having at least two trivalent phosphorus atoms and/or (c) a phosphine having one trivalent phosphorus atom and the alkyne is added only after the phosphonic acid derivative has been brought into contact with the catalyst complex system for at least one minute.

The present invention relates to a process for preparing an alkenylphosphonic acid derivative by reacting a phosphonic acid derivative with an alkyne in the presence of a catalyst complex system.

Vinylphosphonic acid derivatives, in particular dialkyl vinylphosphonates, are important as precursors for the preparation of vinylphosphonic acids and as monomers for co-polymerization for the preparation of adhesives and flame-resistant plastics.

Various methods of preparing them are known.

The process described in DE-A 21 32 962 starts out from ethylene oxide and phosphorus trichloride. The tris(2-chloroethyl) phosphite obtained initially as reaction product is rearranged at 140-200° C. to form bis(2-chloroethyl) 2-chloroethanephosphonate and is then reacted with phosgene in the presence of a catalyst to give 2-chloroethanephosphonyl dichloride and vinylphosphonyl dichloride. Catalysts which can be used are amines, heterocyclic nitrogen compounds and phosphines and also phosphine oxides.

EP 0 032 663A2 describes a process for preparing vinylphosphonic acid derivatives in which dialkyl 2-acetoxyethanephosphonates are dissociated in the presence of acidic or basic catalysts. Basic catalysts proposed are tertiary amines and phosphines, ammonium salts or phosphonium salts, heterocyclic compounds and acid amides. A disadvantage of the process is the formation of a mixture of vinylphosphonic acid derivatives. The proportion of dialkyl vinylphosphonates is not more than 23%.

An improved variant of this process which is described in DE 31 20 437A1 comprises reacting the product mixture obtained with ortho esters of carboxylic acids to form dialkyl vinylphosphonates.

Disadvantages of the above processes are the formation of product mixtures, complicated, multistage syntheses, the necessity of using high reaction temperatures and the use of chlorinated starting compounds. The large proportion of by-products in particular has a serious adverse effect on the process economics.

A further synthetic route for preparing diesters of alkenylphosphonic acids is the addition of alkynes onto phosphonic diesters in the presence of a palladium complex as catalyst. An advantage of this synthetic route is a pure addition reaction without formation of stoichiometric amounts of by-products or coproducts.

U.S. Pat. No. 5,693,826 and WO 98/46613 disclose the addition reaction in the presence of a palladium complex having phosphines and phosphites as ligands at less than or equal to 100° C.

WO 99/67259 and U.S. Pat. No. 6,111,127 disclose bidentate phosphines as ligands.

A disadvantage of these processes is the use of expensive noble metal catalysts.

U.S. Pat. No. 3,673,285 describes the addition of alkynes onto phosphonic diesters to form alkenylphosphonic diesters at from 130 to 200° C. in the presence of nickel complexes selected from the group consisting of dicarbonyl-bis(triphenylphosphine)nickel(0), bis(tris(hydroxymethyl)phosphine)nickel(II) chloride, bis(tri-n-butylphosphine)nickel(II) bromide and tetracarbonylnickel(0). In the addition of ethyne onto diethyl phosphite in the presence of bis(tri-n-butylphosphine)nickel(II) bromide, a yield of diethyl vinylphosphonate of 40% was achieved (example 15). Disadvantages of this process are a low yield of significantly below 50% and the high reaction temperature of up to 200° C., which leads to exothermic decomposition of the ethyl phosphonate.

EP-A1-1 203 773 (BASF Aktiengesellschaft) describes a process for preparing alkenylphosphonic acid derivatives by reacting phosphonic acid derivatives with alkynes in the presence of a catalyst complex system, in which a catalyst complex system comprising (a) nickel and (b) a phosphine having at least two trivalent phosphorus atoms is used.

A parallel BASF patent application having the same filing date relates to a process for preparing an alkenylphosphonic acid derivative by reacting a phosphonic acid derivative with an alkyne in the presence of a catalyst complex system comprising (a) nickel, (b) a phosphine having at least two trivalent phosphorus atoms and additionally (c) a phosphine having one trivalent phosphorus atom.

It is an object of the present invention to find a process for preparing alkenylphosphonic acid derivatives which overcomes the disadvantages of the prior art, forms no coproducts, allows a reaction temperature of significantly below 200° C., makes a high yield of significantly above 50%, in particular above 75%, possible, does without the use of an expensive noble metal catalyst and gives yields and selectivities which are better than those in EP-A1-1 203 773.

We have found that this object is achieved by a process for preparing an alkenylphosphonic acid derivative by reacting a phosphonic acid derivative with an alkyne in the presence of a catalyst complex system, wherein the catalyst complex system comprises
(a) nickel and
(b) a phosphine having at least two trivalent phosphorus atoms and/or
(c) a phosphine having one trivalent phosphorus atom
   and the alkyne is added only after the phosphonic acid derivative has been brought into contact with the catalyst complex system for at least one minute.

Thus, important aspects of the process of the present invention are the presence of a catalyst complex system comprising (a) nickel and [(b) a phosphine having at least two trivalent phosphorus atoms and/or (c) a phosphine having one trivalent phosphorus atom] and the fact that the alkyne is added only after the phosphonic acid derivative has been brought into contact with the catalyst complex system for at least 1 minute, preferably for from 1 to 60 minutes, in particular for at least 5 minutes, very particularly preferably for from 5 to 30 minutes, especially for from 5 to 15 minutes.

In particular, the nickel (a) is present in the catalyst complex system in the oxidation state zero [═Ni(0)].

In customary terminology, phosphines having one trivalent phosphorus atom are referred to as monophosphines, phosphines having two trivalent phosphorus atoms are referred to as diphosphines, phosphines having three trivalent phosphorus atoms are referred to as triphosphines, etc.

In general, the phosphines having at least two trivalent phosphorus atoms which can be used in the process of the present invention have the formula (I) 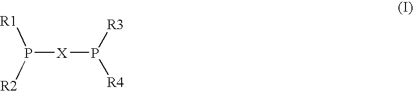
where R¹, R², R³ and R⁴ are each, independently of one another, a carbon-containing organic radical and X is a carbon-containing organic bridging group.

For the purposes of the present invention, a carbon-containing organic radical is an unsubstituted or substituted, aliphatic, aromatic or araliphatic radical having from 1 to 30 carbon atoms. This radical can contain one or more heteroatoms such as oxygen, nitrogen, sulfur or phosphorus, for example —O—, —S—, —NR—, —CO—, —N═, —PR— and/or —PR₂ and/or be substituted by one or more functional groups containing, for example, oxygen, nitrogen, sulfur and/or halogen, for example by fluorine, chlorine, bromine, iodine and/or a cyano group (the radical R here is likewise a carbon-containing organic radical). If the carbon-containing organic radical contains one or more heteroatoms, it can also be bound via a heteroatom. Thus, for example, ether, thioether and tertiary amino groups are also included. The carbon-containing organic radical can be a monovalent or polyvalent, for example divalent, radical.

For the purposes of the present invention, a carbon-containing organic bridging group is an unsubstituted or substituted, aliphatic, aromatic or araliphatic divalent group having from 1 to 20 carbon atoms and from 1 to 10 atoms in the chain. The organic bridging group can contain one or more heteroatoms such as oxygen, nitrogen, sulfur or phosphorus, for example —O—, —S—, —NR—, —CO—, —N—, —PR— and/or —PR₂ and/or be substituted by one or more functional groups containing, for example, oxygen, nitrogen, sulfur and/or halogen, for example by fluorine, chlorine, bromine, iodine and/or a cyano group (the radical R here is likewise a carbon-containing organic radical). If the organic bridging group contains one or more heteroatoms, it can also be bound via a heteroatom. Thus, for example, ether, thioether and tertiary amino groups are also included.

In the process of the present invention, preference is given to using a phosphine (I) in which the radicals R¹, R², R³ and R⁴ are each, independently of one another,
an unbranched or branched, acyclic or cyclic, unsubstituted or substituted alkyl radical which has from 1 to 20 aliphatic carbon atoms and in which one or more of the CH₂ groups may also be replaced by heteroatoms such as —O— or by heteroatom-containing groups such as —CO— or —NR— and one or more of the hydrogen atoms may be replaced by substituents such as aryl groups;
an unsubstituted or substituted aromatic radical which has one ring or two or three fused rings and in which one or more ring atoms may be replaced by heteroatoms such as nitrogen and one or more of the hydrogen atoms may be replaced by substituents such as alkyl or aryl groups;
   or in which the radicals R¹ together with R² and/or R³ together with R⁴ form
an unsubstituted or substituted, aliphatic, aromatic or araliphatic group having from 3 to 10 atoms in the chain.

Examples of preferred monovalent radicals R¹, R², R³ and R⁴ are methyl, ethyl, 1-propyl, 2-propyl (sec-propyl), 1-butyl, 2-butyl (sec-butyl), 2-methyl-1 -propyl (isobutyl), 2-methyl-2-propyl (tert-butyl), 1-pentyl, 2-pentyl, 3-pentyl, 2-methyl-2-butyl (tert-amyl), 1-hexyl, 2-hexyl, 3-hexyl, 2-methyl-2-pentyl, 3-methyl-3-pentyl, 2-methoxy-2-propyl, methoxy, ethoxy, 1-propoxy, 2-propoxy (sec-propoxy), 1-butoxy, 2-butoxy (sec-butoxy), 2-methyl-1-propoxy (isobutoxy), 2-methyl-2-propoxy (tert-butoxy), 1-pentoxy, 2-pentoxy, 3-pentoxy, 2-methyl-2-butoxy (tert-amoxy), 1-hexoxy, 2-hexoxy, 3-hexoxy, 2-methyl-2-pentoxy, 3-methyl-3-pentoxy, phenyl, 2-methylphenyl (o-tolyl), 3-methylphenyl (m-tolyl), 4-methylphenyl (p-tolyl), 2,6-dimethylphenyl, 2,4-dimethylphenyl, 2,4,6-trimethylphenyl, 2-methoxyphenyl, 3-methoxyphenyl, 4-methoxyphenyl, 2-pyridyl, 3-pyridyl, 4-pyridyl, 3-pyridazinyl, 4-pyridazinyl, 5-pyridazinyl, 2-pyrimidinyl, 4-pyrimidinyl, 5-pyrimidinyl, 2-pyrazinyl, 2-(1,3,5-triazin)yl, 1-naphthyl, 2-naphthyl, 2-quinolyl, 8-quinolyl, 1-isoquinolyl and 8-isoquinolyl.

Examples of preferred divalent radicals R¹ together with R² and/or R³ together with R⁴ are 1,4-butylene, 1,4-dimethyl-1,4-butylene, 1,1,4,4-tetramethyl-1,4-butylene, 1,4-dimethoxy-1,4-butylene, 1,4-dimethyl-1,4-dimethoxy-1,4-butylene, 1,5-pentylene, 1,5-dimethyl-1,5-pentylene, 1,5-dimethoxy-1,5-pentylene, 1,1,5,5-tetramethyl-1,5-pentylene, 1,5-dimethyl-1,5-dimethoxy-1,5-pentylene, 3-oxa-1,5-pentylene, 3-oxa-1,5-dimethyl-1,5-pentylene, 3-oxa-1,5-dimethoxy-1,5-pentylene, 3-oxa-1,1,5,5-tetramethyl-1,5-pentylene, 3-oxa-1,5-dimethyl-1,5-dimethoxy-1,5-pentylene,

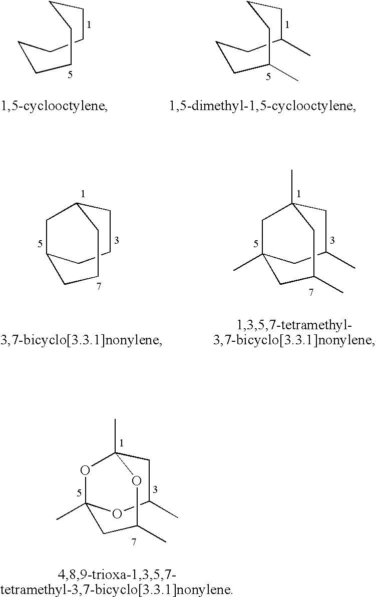

The process of the present invention is particularly preferably carried out using a phosphine (I) in which R¹, R², R³ and/or R⁴ are each, independently of one another, an unsubstituted or substituted C₃-C₁₂-alkyl radical in which not more than one atom from the group consisting of hydrogen, fluorine, chlorine, bromine and iodine is bound to the α carbon atom; and/or R¹, R², R³ and/or R⁴ are each, independently of one another, an unsubstituted or substituted aromatic radical which has six ring atoms and in which one, two or three ring atoms may be replaced by nitrogen; and/or in which R¹ together with R² and/or R³ together with R⁴ form an unsubstituted or substituted, aliphatic, aromatic or araliphatic group which has from 4 to 7 atoms in the chain and a total of not more than 30 carbon atoms.

The unsubstituted or substituted C₃- to C₁₂-alkyl radical in which not more than one atom from the group consisting of hydrogen, fluorine, chlorine, bromine and iodine is bound to the α carbon atom is an alkyl radical which is branched at the α carbon atom. Preference is given to at least two further carbon atoms being bound to the α carbon atom. The third atom bound to the α carbon atom is preferably hydrogen, carbon or a heteroatom such as oxygen, nitrogen or sulfur. Preferred examples are 2-propyl (sec-propyl), 2-butyl (sec-butyl), 2-methyl-2-propyl (tert-butyl), 2-methyl-2-butyl (tert-amyl) and 2-methoxy-2-propyl.

Preferred examples of unsubstituted or substituted aromatic radicals which have six ring atoms and in which one, two or three ring atoms may be replaced by nitrogen are phenyl, 2-methylphenyl (o-tolyl), 3-methylphenyl (m-tolyl), 4-methylphenyl (p-tolyl), 2,6-dimethylphenyl, 2,4-dimethylphenyl, 2,4,6-trimethylphenyl and 2-pyridyl.

Preferred examples of divalent radicals R¹ together with R² and/or R³ together with R⁴ are 1,1,4,4-tetramethyl-1,4-butylene, 1,4-dimethyl-1,4-dimethoxy-1,4-butylene, 1,1,5,5-tetramethyl-1,5-pentylene, 1,5-dimethyl-1,5-dimethoxy-1,5-pentylene, 1,5-dimethyl-1,5-cyclooctylene, 1,3,5,7-tetramethyl-3,7-bicyclo[3.3.1]nonylene and 4,8,9-trioxa-1,3,5,7-tetramethyl-3,7-bicyclo[3.3.1]nonylene.

Very particular preference is given to using a phosphine (I) in which the radicals R¹, R², R³ and R⁴ are each a 2-methyl-2-propyl (tert-butyl) or phenyl group in the process of the present invention.

In the process of the present invention, preference is given to using a phosphine (I) in which X is an unsubstituted or substituted, aliphatic, aromatic or araliphatic group which has from 1 to 8 atoms, preferably from 2 to 4 atoms, in the chain and a total of not more than 20 carbon atoms. In this group, one or more of the CH₂ groups may be replaced by heteroatoms such as —O— or heteroatom-containing groups such as —CO— or —NR— and/or one or more of the aromatic ring atoms may be replaced by heteroatoms such as nitrogen.

Examples of preferred bridging groups X are 1,2-ethylene, 1,3-propylene, 1,2-propylene, 1,4-butylene, 2-methyl-1,3-propylene, 1,5-pentylene, 2,2-dimethyl-1,3-propylene, 1,6-hexylene, —O—CH₂CH₂—O—, —O—CH₂CH₂CH₂—O—, o-phenylene, o-xylylene (=ortho —CH₂—C₆H₄—CH₂—) and 2,2′-biphenylene.

The process of the present invention is particularly preferably carried out using a phosphine (I) in which the bridging group X is a 1,2-ethylene, 1,3-propylene, 1,4-butylene or o-xylylene group.

Very particular preference is given to using a phosphine (I) in which the radicals R¹ to R⁴ are each a 2-methyl-2-propyl (tert-butyl) or phenyl group and X is a 1,2-ethylene, 1,3-propylene, 1,4-butylene or o-xylylene group in the process of the present invention.

Very particularly preferred examples are 1,2-bis(di-tert-butylphosphino)ethane, 1,2-bis (diphenylphosphino)ethane, 1,3-bis(di-tert-butylphosphino)propane, 1,3-bis(diphenylphosphino)propane, 1,4-bis(di-tert-butylphosphino)butane, 1,4-bis(diphenylphosphino)butane, bis(di-tert-butylphosphino)o-xylene and bis(diphenylphosphino)-o-xylene, in particular 1,3-bis(di-tert-butylphosphino)propane and 1,3-bis(diphenylphosphino)propane.

The synthesis of diphosphines is generally known and is described, for example, in L. Brandsma et al., “Application of Transition Metal Catalysts in Organic Synthesis”, Springer-Verlag, Berlin 1997, pages 6 to 9.

The optional phosphine having one trivalent phosphorus atom (c) in the Ni catalyst system is generally a phosphine of the formula (IV) 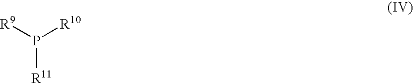
where R⁹, R¹⁰, R¹¹ are each, independently of one another, a carbon-containing organic radical.

For the purposes of the present invention, a carbon-containing organic radical is an unsubstituted or substituted, aliphatic, aromatic or araliphatic radical having from 1 to 30 carbon atoms. This radical may contain one or more heteroatoms such as oxygen, nitrogen, sulfur or phosphorus, for example —O—, —S—, —NR—, —CO—, —N═, —PR— and/or —PR₂ and/or be substituted by one or more functional groups containing, for example, oxygen, nitrogen, sulfur and/or halogen, for example by fluorine, chlorine, bromine, iodine and/or a cyano group (the radical R here is likewise a carbon-containing organic radical). If the carbon-containing organic radical contains one or more heteroatoms, it can also be bound via a heteroatom. Thus, for example, ether, thioether and tertiary amino groups are also included. The carbon-containing organic radical can be a monovalent or polyvalent, for example divalent, radical.

R⁹, R¹⁰, R¹¹ are preferably (independently of R¹⁻⁴) radicals and groups as defined above for R¹⁻⁴.

Very particular preference is given to R⁹, R¹⁰, R¹¹ each being a C₃₋₆-cycloaliphatic and/or aromatic radical such as cyclohexyl or phenyl.

If a phosphine having a trivalent phosphorus atom (c) and the formula (IV) is present in the Ni catalyst system, it is, in a preferred embodiment, triphenylphosphine and/or tri-cyclohexylphosphine.

In the process of the present invention, the catalyst complex system is generally prepared by combining an Ni(0) complex and one of the two phosphines (b or c) or both the phosphines (b and c), where the phosphines have, in particular, the formulae I and IV, respectively, or by combining an Ni(II) compound, a reducing agent and one of the two phosphines (b or c) or both the phosphines (b and c), where the phosphines have, in particular, the formulae I and IV, respectively.

Since the respective phosphonic acid derivative can also act as reducing agent, the catalyst complex system can also be obtained by combining an Ni(II) compound and the phosphines b and/or c, where the phosphines have, in particular, the formulae I and IV, respectively, and a phosphonic acid derivative without a further reducing agent.

When carrying out the first-named variant, it is in principle possible to use all Ni(0) complexes which react with the phosphine under the reaction conditions to form a catalyst complex system. Examples of suitable Ni complexes are tetracarbonylnickel, bis(cycloocta-1,5-diene)nickel and (cyclododeca-1,5,9-triene)nickel.

The Ni(II) compounds required for the second variant can be of an inorganic, organic or mixed nature. Examples are nickel(II) halides (e.g. NiCl₂), nickel(II) sulfate, nickel(II) acetylacetonate, 1,3-bis(diphenylphosphino)propanenickel(II) chloride, hexamminenickel(II) chloride, nickel bromide.diethylene glycol dimethyl ether complexes, dimethylnickel(II) complexes (CH₃)₂NiL₂ (L=for example, triphenylphosphine, triethylphosphine, tributylphosphine) and dimethyinickel(II) complexes (CH₃)₂NiL (L=for example, tetramethylethylenediamine (TMEDA), bis(diphenylphosphino)propane, bis(diphenylphosphino)butane). Suitable reducing agents are, for example, elemental zinc, trialkylboron compounds, trialkylaluminum compounds, diisobutylaluminum hydride and phosphonic acid derivatives.

The catalyst complex system can be prepared in a separate step prior to the actual alkenylation of the phosphonic acid derivative or in situ by combining the abovementioned components.

The temperature in the preparation of the catalyst complex system is generally from 30 to 120° C., preferably from 60 to 110° C.

As solvent, it is generally possible to use the phosphonic acid derivative as long as this is liquid under the reaction conditions. However, it is also possible and may be advantageous to prepare the catalyst complex system in the presence of a further, inert solvent. In this case, preference is given to using the same solvents which can also be used as solvents for the alkenylation reaction and are described in more detail below.

If the catalyst complex system comprises (a) nickel and (b) a phosphine having at least two trivalent phosphorus atoms and (c) a phosphine having one trivalent phosphorus atom, the molar ratio of the two phosphines (total molar amount) to the nickel of the catalyst complex system is generally from 0.5 to 6, preferably from 1 to 4 and particularly preferably from 2.5 to 3.5, in the process of the present invention.

The molar ratio of nickel:(phosphine having at least two trivalent phosphorus atoms): (phosphine having one trivalent phosphorus atom) is preferably 1:(0.5-2):(1-4), in particular 1:(1-1.3):(1.5-2).

If the catalyst complex system comprises (a) nickel and (b) a phosphine having at least two trivalent phosphorus atoms and no phosphine having one trivalent phosphorus atom (c), the molar ratio of the phosphine to the nickel of the catalyst complex system is generally from 0.5 to 6, preferably from 1 to 4 and particularly preferably from 1.5 to 2.5, in the process of the present invention.

If the catalyst complex system comprises (a) nickel and (c) a phosphine having one trivalent phosphorus atom and no phosphine having at least two trivalent phosphorus atoms (b), the molar ratio of the phosphine to the nickel of the catalyst complex system is generally from 0.5 to 8, preferably from 2 to 6 and particularly preferably from 3.5 to 4.5, in the process of the present invention.

The molar ratio of the nickel of the catalyst complex system to the phosphorus of the phosphonic acid derivative and the products formed therefrom is generally from 0.01 to 10%, preferably from 0.05 to 5% and particularly preferably from 0.05 to 3%, in the process of the present invention.

The reaction of the phosphonic acid derivative with the alkyne can be carried out at from 0 to 200° C., preferably from 20 to 150° C., particularly preferably from 50 to 120° C., in particular from 50 to 100° C.

The reaction of the phosphonic acid derivative with the alkyne is generally carried out at a pressure of from 0.01 to 5 MPa abs., preferably from 0.05 to 2.5 MPa abs., particularly preferably from 0.05 to 0.14 MPa abs., in particular at atmospheric pressure.

The process of the present invention can be carried out in the absence of an additional solvent (“solvent-free”) or in the presence of an inert solvent. For the purposes of the present invention, inert solvents are solvents which do not react chemically with the compounds used under the reaction conditions set. Suitable inert solvents are, for example, tetrahydrofuran, 1,4-dioxane, N-methylpyrrolidone, N-methylpiperidone, dimethyl sulfoxide, toluene, xylene, glycol ethers (e.g. 1,2-dimethoxyethane (ethylene glycol dimethyl ether), bis(2-methoxyethyl) ether (diethylene glycol dimethyl ether), triethylene glycol dimethyl ether or tetraethylene glycol dimethyl ether), dimethylformamide, dimethylformanilide, chlorobenzene and mixtures thereof. The addition of an inert solvent can, for example, be advantageous when using relatively high molecular weight phosphonic acid derivatives which are viscous or solid under the reaction conditions.

It may be advantageous to carry out the process of the present invention in the presence of a free-radical inhibitor as additive. In principle, suitable free-radical inhibitors are the inhibitors customary in industry, for example N,N′-bis(1-methylpropyl)-1,4-phenylenediamine, 2,6-di-tert-butyl-4-methylphenol or 1,2-dihydroxybenzene (catechol).

If a free-radical inhibitor is used, the molar ratio of the free-radical inhibitor to the phosphorus of the phosphonic acid derivative and the products formed therefrom is generally from 0.01 to 10%, preferably from 0.05 to 5% and particularly preferably from 0.5 to 3%.

The phosphonic acid derivatives to be used in the process of the present invention are generally known and have, for example, the formula (II) 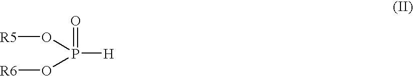
where R⁵ and R⁶ are each, independently of one another, a carbon-containing organic radical. For the definition of the term “carbon-containing organic radical”, reference is made to what has been said above with regard to the definition of the radicals R¹ to R⁴ in the formula (I).

R⁵, R⁶ are preferably (independently of R¹⁻⁴) radicals and groups as have been defined above for R¹⁻².

Phosphonic acid derivatives of the formula (II) are generally prepared by reacting phosphorus trichloride with the corresponding alcohols and/or the corresponding phenols. Further details may be found, for example, in Ullmann's Encyclopedia of Industrial Chemistry, 6^{th} edition, 1999 Electronic Release, Chapter “Phosphorus Compounds, Organic-Phosphites and Hydrogenphosphonates”.

In the process of the present invention, preference is given to using a phosphonic acid derivative (II) in which the radicals R⁵ and R⁶ are each, independently of one another,
an unbranched or branched, acyclic or cyclic, unsubstituted or substituted alkyl radical which has from 1 to 20 aliphatic carbon atoms and in which one or more of the CH₂ groups may also be replaced by heteroatoms such as —O— or by heteroatom-containing groups such as —CO— or —NR— and one or more of the hydrogen atoms may be replaced by substituents such as aryl (e.g. phenyl), alkyl (e.g. C₁₋₁₀-alkyl), hydroxyalkyl (e.g. C₁₋₁₀-hydroxyalkyl), haloalkyl (e.g. C₁₋₁₀-haloalkyl), acetoxyalkyl (e.g. acetoxy-C₁₋₁₀-alkyl);
an unsubstituted or substituted aromatic radical which has one ring or two or three fused rings and in which one or more ring atoms may be replaced by heteroatoms such as nitrogen and one or more of the hydrogen atoms may be replaced by substituents such as alkyl or aryl groups;
   or in which the radicals R⁵ together with R⁶ form
an unbranched or branched, acyclic or cyclic, unsubstituted or substituted C₄-C₂₀-alkylene radical which has from 4 to 10 atoms in the alkylene chain and in which CH₂ groups may also be replaced by heterogroups such as —CO—, —O— or —NR— and one or more of the hydrogen atoms may be replaced by substituents such as aryl groups.

Examples of preferred radicals R⁵ and R⁶ are
C₁-C₁₂-alkyl, particularly preferably methyl, ethyl, 1-propyl, 2-propyl, 1-butyl, 2-butyl, 2-methyl-1-propyl, 2-methyl-2-propyl, 1-pentyl, 1-hexyl, 1 -octyl, 2-ethyl-1-hexyl, 1-decyl and 1-dodecyl;
C₆-C₁₀-aryl, particularly preferably phenyl;
C₇-C₁₀-aralkyl, particularly preferably phenylmethyl; and
C₇-C₁₀-alkaryl, particularly preferably 2-methylphenyl, 3-methylphenyl and 4-methylphenyl.

Very particular preference is given to using the dimethyl ester, the diethyl ester, the dipropyl ester, the dibutyl ester, the di(2-ethylhexyl) ester or the diphenyl ester of phosphonic acid as phosphonic acid derivative in the process of the present invention.

The alkynes used in the process of the present invention have the formula (III)
R7—C≡C—R8 (III)
where R⁷ and R⁸ are each, independently of one another, hydrogen or a carbon-containing organic radical. R⁷ and R⁸ may also, if desired, be joined to one another. For the definition of the term “carbon-containing organic radical”, reference is made to what has been said above with regard to the definition of the radicals R¹ to R⁴ in the formula (I).
R⁷, R⁸ are preferably (independently of R¹⁻⁴) radicals and groups as have been defined above for R¹⁻².

The process of the invention is preferably carried out using an alkyne (III) in which the radicals R⁷ and R⁸ are each, independently of one another,
hydrogen (H);
an unbranched or branched, acyclic or cyclic, unsubstituted or substituted alkyl radical which has from 1 to 20 aliphatic carbon atoms and in which one or more of the CH₂ groups may also be replaced by heteroatoms such as —O— or by heteroatom-containing groups such as n—CO— or —NR— and in which one or more of the hydrogen atoms may be replaced by substituents such as aryl groups;
an unsubstituted or substituted aromatic radical which has one ring or two or three fused rings and in which one or more ring atoms may be replaced by heteroatoms such as nitrogen and one or more of the hydrogen atoms may be replaced by substituents such as alkyl or aryl groups.

Examples of preferred radicals R⁷ and R⁸ are
hydrogen (H);
C₁-C₁₀-alkyl, particularly preferably methyl, ethyl, 1-propyl, 1-butyl, 1-pentyl and 1-hexyl;
C₆-C₁₀-aryl, particularly preferably phenyl;
C₇-C₁₀-aralkyl, particularly preferably phenylmethyl; and
C₇-C₁₀-alkaryl, particularly preferably 2-methylphenyl, 3-methylphenyl and 4-methylphenyl.

Very particular preference is given to using ethyne or propyne as alkynes in the process of the present invention.

The process of the present invention is very particularly preferably used to prepare dimethyl ethenylphosphonate, diethyl ethenylphosphonate, di-n-propyl ethenylphosphonate and di-n-butyl ethenylphosphonate.

When, for example, phenylacetylene or, for example, 1-octyne and dimethyl phosphite are used, three isomeric alkenylphosphonic diesters can be formed as reaction products in accordance with the following reaction equation (R′=phenyl or R′=n-hexyl):

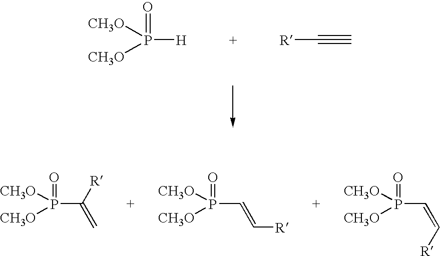

The process of the present invention can be carried out batchwise, semicontinuously or continuously.

According to the present invention, it has been recognized that the yield of alkenylphosphonic acid derivative and the selectivity of the reaction are increased when the alkyne is added only after the phosphonic acid derivative has been brought into contact with the catalyst complex system for at least one minute.

The prior contacting of the phosphonic acid derivative with the catalyst complex system (induction phase) reduces or even prevents the undesirable dimerization or polymerization of the alkyne which can also lead to a partial loss of catalyst. The prior in-situ formation of a presumed complex [nickel-phosphine-phosphonic acid derivative] apparently has an advantageous effect.

The prior contacting of the phosphonic acid derivative with the catalyst complex system (induction phase) is generally carried out at from 0 to 200° C., preferably from 20 to 150° C., particularly preferably from 50 to 120° C., in particular from 50 to 100° C.

In an example of a batch process, the phosphine(s) (b and/or c), in particular phosphine(s) of the formula I and/or IV, the Ni complex (or the Ni(II) compound and the reducing agent), the phosphonic acid derivative, if desired a solvent and if desired a free-radical inhibitor are combined, mixed and brought to the reaction conditions. After at least one minute, generally after from 1 to 60 minutes, preferably at least 5 minutes, in particular from 5 to 30 minutes, the alkyne is added to the reaction mixture which has been brought to the reaction conditions. After the reaction is complete, the reaction mixture is passed to the work-up, preferably by distillation, and the desired alkenylphosphonic acid derivative is isolated.

In an example of a semicontinuous process, the phosphine(s) (b and/or c), in particular phosphine(s) of the formula I and/or IV, the Ni complex (or the Ni(II) compound and the reducing agent), the phosphonic acid derivative, if desired a solvent and if desired a free-radical inhibitor are combined, mixed and brought to the reaction temperature. The alkyne is then, after the reaction mixture has been maintained at the reaction temperature for at least one minute, generally from 1 to 60 minutes, preferably at least 5 minutes, in particular from 5 to 30 minutes, fed in continuously until the desired amount has been reached. The alkyne can be introduced in gaseous or liquid form. When it is added in liquid form, pure, liquid alkyne or a solution in a solvent can be used. After the addition of alkyne is complete, the reaction mixture can be left under the reaction conditions for a further time. After the reaction is complete, the reaction mixture is passed to the work-up, preferably by distillation, and the desired alkenylphosphonic acid derivative is isolated.

In an example of a continuous process, the phosphine(s) (b and/or c), in particular phosphine(s) of the formula I and/or IV, the Ni complex (or the Ni(II) compound and the reducing agent), if desired a solvent and if desired a free-radical inhibitor are combined, mixed and brought to the reaction temperature. The phosphonic acid derivative and the catalyst-containing mixture are then combined continuously in the desired ratio, brought to the reaction temperature and maintained at this temperature for at least one minute, generally from 1 to 60 minutes, preferably at least 5 minutes, in particular from 5 to 30 minutes.

In a further step, this mixture and the alkyne are combined continuously in the desired ratio. The phosphonic acid derivative is generally added in liquid form, if appropriate as a solution in a solvent. The alkyne can be introduced in gaseous or liquid form. When it is added in liquid form, it is possible to use pure, liquid alkyne or a solution in a solvent. Liquid reaction mixture is taken off continuously and the alkenylphosphonic acid derivative formed is isolated in a downstream stage, for example by distillation or extraction. If desired, relatively high-boiling by-products are also separated off. The remaining mixture, which comprises mainly unreacted phosphonic acid derivative and any solvent used, can, if desired, be recirculated.

The process of the present invention makes it possible to prepare alkenylphosphonic acid derivatives from readily available starting compounds in only one synthesis step at a reaction temperature of preferably below 150° C. without use of an expensive noble metal catalyst. Since the reaction is a very selective addition reaction, no coproducts and only a small amount of by-products are formed. The process of the present invention allows a high yield of significantly above 50%, in particular above 75%, at yields and selectivities which are improved compared to EP-A1-1 203 773 to be achieved with good process economics.

### EXAMPLES

### Example 1

27.50 g of dimethyl phosphite were admixed with 27 ml of tetraethylene glycol dimethyl ether in a three-necked flask provided with an internal thermometer, condenser and gas inlet tube and the mixture was degassed under argon. After addition of 0.5 mol % of Ni(acac)₂ and 1 mol % of dppp (dppp=1,3-bis(diphenylphosphino)propane), the reaction solution was heated to 100° C. and subsequently stirred at this temperature for 10 minutes. 8 l/h of acetylene were then introduced into the reaction solution at 100° C. and atmospheric pressure for 1.5 hours. Work-up by distillation gave dimethyl vinylphosphonate in a yield of 80%.

### Example 2 (Comparative Example)

27.50 g of dimethyl phosphite were admixed with 27 ml of tetraethylene glycol dimethyl ether in a three-necked flask provided with an internal thermometer, condenser and gas inlet tube and the mixture was degassed under argon. After addition of 0.5 mol % of Ni(acac)₂ and 1 mol % of dppp, the solution was heated to 100° C. Even during the heating phase, 8 l/h of acetylene were passed through the reaction solution. After the 10 minute heating phase, 8 l/h of acetylene were introduced into the reaction solution at 100° C. and atmospheric pressure for a further 1.5 hours. Work-up by distillation gave dimethyl vinylphosphonate in a yield of 70%.

1. A process for preparing an alkenylphosphonic acid derivative by reacting a phosphonic acid derivative with an alkyne in the presence of a catalyst complex system, wherein the catalyst complex system comprises
(a) nickel and
(b) a phosphine having at least two trivalent phosphorus atoms and/or
(c) a phosphine having one trivalent phosphorus atom
and the alkyne is added only after the phosphonic acid derivative has been brought into contact with the catalyst complex system for at least one minute.

2. A process as claimed in claim 1, wherein the alkyne is added only after the phosphonic acid derivative has been brought into contact with the catalyst complex system for from 1 to 60 minutes.

3. A process as claimed in claim 1, wherein the alkyne is added only after the phosphonic acid derivative has been brought into contact with the catalyst complex system for at least five minutes.

4. A process as claimed in claim 1, wherein the reaction and the contacting of the phosphonic acid derivative with the catalyst complex system are each carried out at from 20 to 150° C.

5. A process as claimed in claim 1, wherein the reaction and the contacting of the phosphonic acid derivative with the catalyst complex system are each carried out at from 50 to 120° C.

6. A process as claimed in claim 1, wherein the reaction is carried out at a pressure of from 0.05 to 2.5 MPa abs.

7. A process as claimed in claim 1, wherein the catalyst complex system is prepared by combining an Ni(0) complex and the phosphine(s) (b and/or c) or by combining an Ni(II) compound, a reducing agent and the phosphine(s) (b and/or c).

8. A process as claimed in claim 1, wherein from 0.01 to 10 mol % of nickel of the catalyst complex system based on the phosphonic acid derivative to be reacted is used.

9. A process as claimed in claim 1, wherein the phosphonic acid derivative used is the dimethyl ester, the diethyl ester, the dipropyl ester, the dibutyl ester, the di(2-ethylhexyl) ester or the diphenyl ester of phosphonic acid.

10. A process as claimed in claim 1, wherein the alkyne used is ethyne or propyne.

11. A process as claimed in claim 1 for preparing a dialkyl vinylphosphonate by reacting a corresponding dialkyl phosphonate with acetylene.

12. A process as claimed in claim 1, wherein the phosphine having at least two trivalent phosphorus atoms (b) is a phosphine of the formula (I) 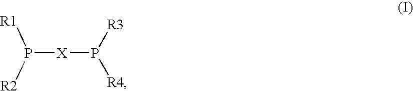
where R¹, R², R³ and R⁴ are each, independently of one another, a carbon-containing organic radical and X is a carbon-containing organic bridging group.

13. A process as claimed in claim 12, wherein X in the phosphine (I) is an unsubstituted or substituted, aliphatic, aromatic or araliphatic group which has from 1 to 8 atoms in the chain and a total of not more than 20 carbon atoms.

14. A process as claimed in claim 12, wherein R¹ to R⁴ in the phosphine (I) are each a 2-methyl-2-propyl group or are each a phenyl group and X is a 1,2-ethylene, 1,3-propylene, 1,4-butylene or o-xylylene group.

15. A process as claimed in claim 1, wherein the phosphine having one trivalent phosphorus atom (c) is a phosphine of the formula (IV) 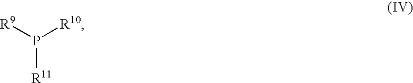
where R⁹, R¹⁰ and R¹¹ are each, independently of one another, a carbon-containing organic radical.

16. A process as claimed in claim 15, wherein R⁹, R¹⁰ and R¹¹ in the phosphine (IV) are each phenyl or cyclohexyl.
